(19) United States
(12) Patent Application Publication
(10) Pub. No.: US 2009/0200118 A1
(43) Pub. Date: Aug. 13, 2009

(54) ELEVATOR CAR PANEL CONNECTION STRUCTURE

(75) Inventors: Masayuki Minami, Aichi (JP); Taiji Sawaki, Aichi (JP); Masaaki Yamada, Aichi (JP); Naohisa Mashimo, Tokyo (JP); Naoki Hashiguchi, Tokyo (JP); Akihiro Kadoi, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku, Tokyo (JP)

(21) Appl. No.: 12/307,430

(22) PCT Filed: Jul. 11, 2006
(86) PCT No.: PCT/JP2006/313755

§ 371 Date: Feb. 12, 2009

(51) Int. Cl. B66B 11/02

(52) U.S. Cl. 187/401

(57) ABSTRACT

An elevator car panel connection structure for connecting car panels constructing elevator car is provided with a first channel-shaped bent portion disposed along a connection edge portion of a first car panel and having a channel-shaped cross-sectional configuration defining an opening and an inner space with a width larger than that of the opening, and a second channel-shaped bent portion disposed along a connection edge portion of a second car panel and having a channel-shaped cross-sectional configuration defining a base portion width that is larger than the width of the opening of the first car panel and that is smaller than the width of the inner space of the first car panel. The second channel-shaped bent portion is pressure fitted into the inner space of the first channel-shaped bent portion through the opening so that the first and the second channel-shaped bent portion are elastically connected and held together. The first channel-shaped bent portion includes a first side wall, a bottom wall and a second side wall and is disposed along the inner space and the connection edge portion. The second channel-shaped bent portion may have a configuration similar to the first channel-shaped bent portion or may have two side walls folded over one another.

### TECHNICAL FIELD

This invention relates to an elevator car panel connection structure.

### BACKGROUND ART

An elevator car uses car panels such as wall panels for defining an elevator car compartment. The connection between the car panels has heretofore been generally established by bending the connection edge portion of the panel to provide fastening portions, and fastening these fastening portions to each other by fasteners such as bolts or clips (see Patent Document 1, for example). It is also proposed, for connecting wall panels without using the fasteners, to provide connection portions of the panel with wedge configuration portions and to use their wedging effect to connect the wall panels (see Patent Document 2, for example).

[Patent Document 1] Japanese Patent Laid-Open No. 9-77431

[Patent Document 2] Japanese Patent Laid-Open No. 2001-302149

### DISCLOSURE OF THE INVENTION

### Problems to be Solved be the Invention

However, when bolts are to be used, the connecting operation needs time, and the operation cannot be achieved from inside of the car compartment and fine assembly adjustment is necessary and difficult. Also, although the operation time can be significantly reduced when clips are used, the problem of a large number of parts still remains to be solved. Further, in the structure utilizing the wedging effect, the wall panels may easily come out of engagement when a force acts in the direction opposite to the engaging direction.

Accordingly, the object of the present invention is to provide an elevator car panel connecting structure in which the structure is simple, no special part is required and assembly is easy and precise.

### Measure for Solving the Problem

With the above object in view, according to the present invention, the elevator car panel connection structure for connecting car panels constructing elevator car comprises;

a first channel-shaped bent portion disposed along a connection edge portion of a first car panel and having a channel-shaped cross-sectional configuration defining an opening and an inner space with a width larger than that of said opening; and

a second channel-shaped bent portion disposed along a connection edge portion of a second car panel and having a channel-shaped cross-sectional configuration defining a base portion width that is larger than the width of said opening of said first car panel and that is smaller than the width of said inner space of said first car panel;

whereby said second channel-shaped bent portion is pressure fitted into said inner space of said first channel-shaped bent portion through said opening so that said first channel-shaped bent portion and said second channel-shaped bent portion are elastically connected and held together.

The second channel-shaped bent portion is pressure fitted into the inner space of the first channel-shaped bent portion through the opening so that the first channel-shaped bent portion and the second channel-shaped bent portion are elastically connected and held together.

### Advantageous Results of the Invention

Thus, according to the present invention, an elevator car panel connecting structure can be provided in which the structure is simple, no special part is required and assembly is easy and precise.

### BRIEF DESCRIPTION OF THE DRAWINGS

FIG. 1 is a schematic section view of the elevator car constructed by car panels connected by the elevator car panel connecting structure of the present invention (Embodiment 1).

FIG. 2 is a schematic sectional view showing a first example of the elevator car panel connecting structure of the present invention (Embodiment 1).

FIG. 3 is a schematic sectional view showing a second example of the elevator car panel connecting structure of the present invention (Embodiment 2).

FIG. 4 is a schematic sectional view showing a second example of the elevator car panel connecting structure of the present invention (Embodiment 3).

FIG. 5 is a schematic sectional view showing a second example of the elevator car panel connecting structure of the present invention (Embodiment 4).

FIG. 6 is a schematic sectional view showing a second example of the elevator car panel connecting structure of the present invention (Embodiment 5).

FIG. 7 is a schematic sectional view showing a second example of the elevator car panel connecting structure of the present invention (Embodiment 6).

FIG. 8 is a schematic sectional view showing a second example of the elevator car panel connecting structure of the present invention (Embodiment 7).

FIG. 9 is a schematic sectional view showing a second example of the elevator car panel connecting structure of the present invention (Embodiment 8).

### BEST MODES FOR CARRYING OUT THE INVENTION

### Embodiment 1

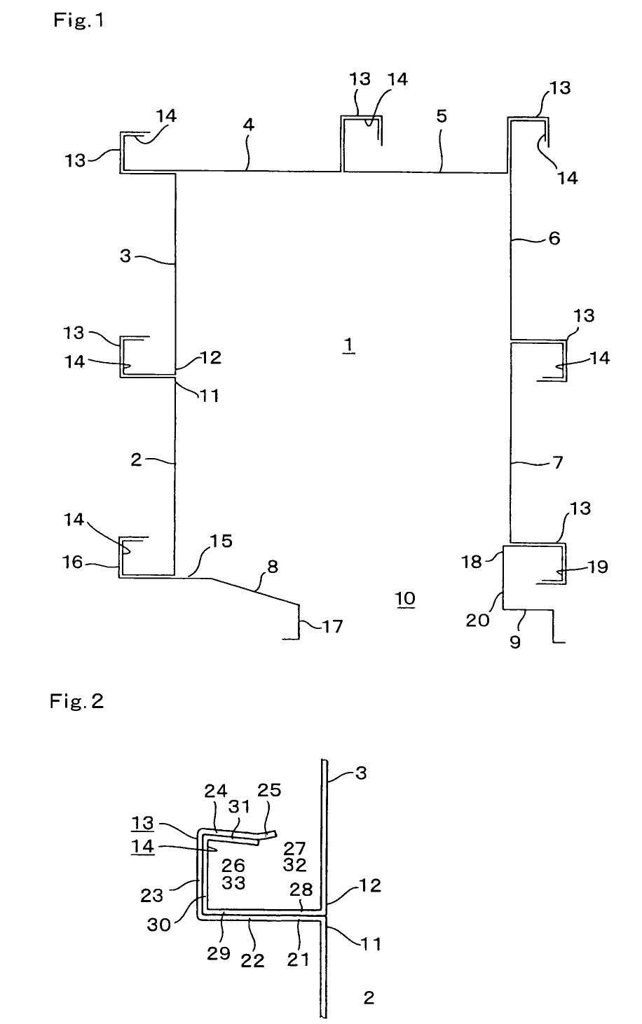

FIG. 1 is a schematic horizontal sectional view showing only car panels of an elevator car compartment 1 constructed by the elevator car panel connecting structure of the present invention. The illustrated car compartment 1 is defined by wall panels 2 to 7 connected to each other and has a car doorway 10 defined by a first doorway panel 8 connected to the wall panel 2 and a second doorway panel 9 connected to the wall panel 7.

These wall panels 2 to 7 as well as the doorway panels 8 and 9 can be assembled together by connecting the elevator car panel connecting structure of the present invention. Also, though not illustrated, the ceiling panels or the floor panels may similarly be assembled together by connecting through the elevator car panel connecting structure of the present invention. In this sense, these wall panels 2 to 7, the doorway panels 8 and 9, the ceiling panels and the floor panels are all same parts, so that these panels are hereinafter referred to as car panels in this application. These car panels are made of a sheet metal suitable for a panel, such as stainless steel, aluminum or the like.

In FIG. 1, the car panel 2 comprises a first connection edge portion 11 to be connected to the neighboring car panel 3 and a second connection edge portion 12 on the side edge opposite to the first connection edge portion 11 and to be connected to the neighboring ca panel or the doorway panel 8, the first connection edge portion 11 being provided with a first channel-shaped bent portion 13 and the second connection edge portion 12 being provided with a second channel-shaped bent portion 14. Similarly, the car panels 3 to 7 are each provided with the first and the second connection edge portions 11 and 12 as well as the first and the second channel-shaped bent portions 13 and 14.

Connected to the second channel-shaped bent portion 14 of the car panel 2 is an only bent edge portion 16 (corresponding to the first channel-shaped bent portion 13) provided on the only connection side edge 15 (corresponding to the first connection edge portion 11) of the doorway panel 8 defining the doorway 10. Another side edge 17 of the car panel 8 is not provided with a channel-shaped bent portion and defines the doorway 10. Also, connected to the first channel-shaped bent portion 13 of the car panel 7 is an only bent edge portion 19 (corresponding to the second channel-shaped bent portion 14) provided on the only connection side edge 18 (corresponding to the second connection edge portion 12) of the doorway panel 9. Another side edge 20 of the doorway panel 9 is not provided with a channel-shaped bent portion and defines the doorway 10.

FIG. 2 illustrates in an enlarged view the structures of the first channel-shaped bent portion 13 of the car panel 2 and the second channel-shaped bent portion 14 of the car panel 3 as well as how they are connected. That is, the car panel 2 is provided with a connection portion 21 disposed along the entire length of the first connection edge portion 11 and bent perpendicularly to extend outwardly of the cage 1. The free end of the connection portion 21 is a continuous extension thereof to define a first side wall 22 of the first channel-shaped bent portion 13, the free end of the first side wall 22 is bent at right angles in parallel to but opposite to the main body of the car panel 2 to define a bottom wall 23, and the free end of the bottom wall 23 is bent at right angles toward the inner space of the car 1 and in parallel to the first side wall 22 to define a second side wall 24 which is a bent portion. In the illustrated example, the bottom wall 23 and the second side wall 24 are bent so that the angle defined between them is slightly smaller than the right angle. The free end of the second side wall 24 is further provided with a guide portion 25 for guiding a second channel-shaped bent portion of the car panel 3 as will be explained later in detail.

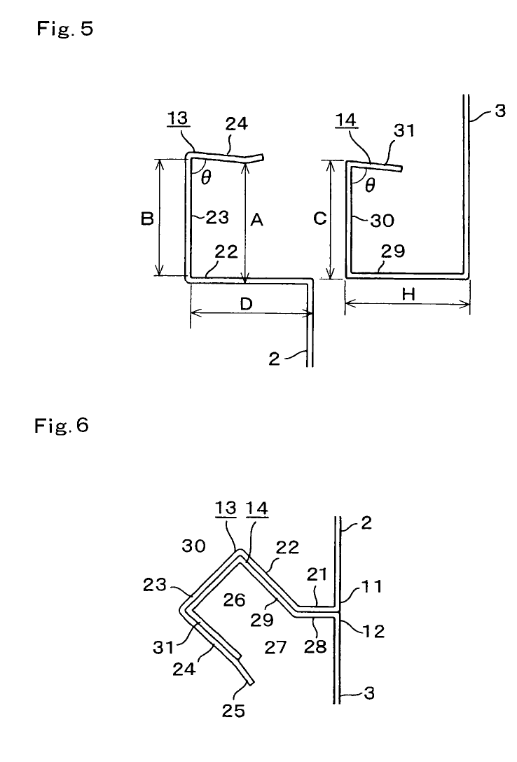

Thus, the first channel-shaped bent portion 13 which is a channel member having a generally U-shaped cross-section connected to the car panel 2 by the connecting portion 21 has an inner space 26 defined by the first side wall 22, the second side wall 24 and the bottom wall 23 along the first connection edge portion 11, the inner space 26 has an opening 27 defined between the first side wall 22 and the second side wall 24 to de provided along the first connection edge portion 11 to communicate with the inner space 26. The opening 27 has a width A (the distance between the first side wall 22 and the second side wall 24 as measured at the entrance of the inner space 26) that is smaller than a width B (the distance between the side wall 22 and the second side wall 24 as measured at the position of the bottom wall 23 which is the bottom of the inner space 26) of the inner space 26. In order to make the width B larger than the width B, the second side wall 24 is bent so that the angle defined between the bottom wall 23 and the second side wall 24 (angle θ shown in FIG. 5) is slightly smaller than the right angle. Thus, the first channel-shaped bent portion 13 has a channel-shaped cross-sectional configuration disposed along the connection edge portion 11 of the first car panel 2 and including the inner space 26 having the opening 27 of the width A and the width B larger than the opening 27.

The second channel-shaped bent portion 14 disposed on the second connection edge portion 12 of the car panel 3 is a generally U-shaped channel-shaped member similar to the first channel-shaped bent portion 13. The second channel-shaped bent portion 14 comprises a connecting portion 28 extending toward outside of the car 1 at right angles from the connection edge portion 12, a first side wall 29 which is a continuous extension from the connecting portion 28, a bottom wall 30 bent at right angles in parallel to the main body of the car panel 3 from the tip of the first side wall 29, and a second side wall 31 which is a bent portion extending at substantially right angles from the tip of the bottom wall 30 toward the inside of the car 1 and in parallel to the first side wall 29. In the illustrated example, the angle defined between the bottom wall 30 and the second side wall 31 is the same as the angle between the bottom wall 23 and the second side wall 24 of the first channel-shaped bent portion 14 and is slightly smaller than the right angle (the angle θ shown in FIG. 5).

The second channel-shaped bent portion 14 also comprises, as shown in FIG. 2, an opening 32 and an inner space 33 similar to the first channel-shaped bent portion 13. Also, the width C of the outside of the body portion of the channel portion formed by the first and second side walls and the bottom wall is larger than the width of the opening 27 of the first channel-shaped bent portion 13 but is smaller than the width of the inner space 26. In the illustrated example, the width C of the body is the outer width dimension of the bottom portion of the channel and is equal to the width B of the inner space 26 of the first channel-shaped bent portion 13. The position of the free edge of the guide portion 25 of the first channel-shaped bent portion 13 is further beyond the free edge of the second side wall 24 and outside of the channel.

Since the first and the second channel-shaped bent portions 13 and 14 have the structure as described above, when the channel-shaped body portion of the second channel-shaped bent portion 14 is inserted into the opening 27 of the first channel-shaped bent portion 13 from the right in FIG. 2, the body portion of the width C of the first channel-shaped bent portion 13 abuts against the first side wall 22 and the guide portion 25 of the second channel-shaped bent portion 14. When the second channel-shaped bent portion 14 is pushed toward left along the first side wall 22, it is slidingly moved along the slanted surface of the guide portion 25 and pushes the second side wall 24 outwardly against the elasticity of the bottom wall 23 and the second side wall 24 into the opening 27. When the body portion of the width C moves beyond the connection portion between the second side wall 24 and the guide portion 25 at which the opening 27 is the narrowest, the elasticity of the side wall 24 serves to pull the second channel-shaped portion 14 into the first channel-shaped portion 13 due to the slant angles of the side walls 24 and 31.

Finally, the second channel-shaped bent portion 14 rests at the position at which it is held in the first channel-shaped bent portion 13 as shown in FIG. 2. In this position, the first side walls 22 and 29, the bottom walls 23 and 30, and the second side walls 24 and 31 are in the state in which they are brought into contact so that a friction is generated by the elasticity, and the first channel-shaped portion 13 and the second channel-shaped portion 14 are elastically connected and held in the state in which friction generates. Thus, it can be said that the first channel-shaped bent portion 13 serves as a clip for holding the second channel-shaped bent portion 14.

As illustrated in FIG. 1, the first and the second channel-shaped bent portions 13 and 14 of the car panels 2, 3, 5-7 constituting the elevator car 1 are all identical in configuration and dimension and there is no limit in number of panels to be connected and in interchangeability.

According to the elevator car panel connection structure of the present invention, the first and the second channel-shaped bent portions 13 and 14, which are continuously and integrally provided to the car panels 2 and 3, respectively, as one piece, elastically engages to each other like clips and hold each other, so that no securing fittings such as bolts and nuts are necessary and the connecting operations can be achieved from the inside of the car compartment, thus significantly reducing the number of the parts and significantly shorten the elevator car compartment assembly time.

### Embodiment 2

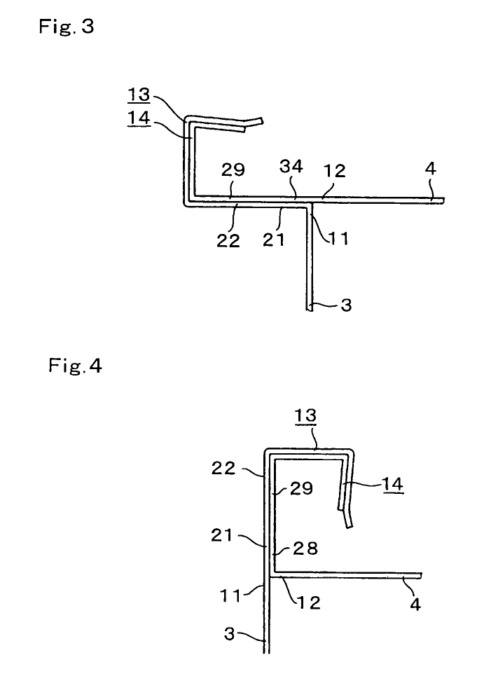

As explained before in conjunction with FIGS. 1 and 2, the first and the second channel-shaped bent portions 13 and 14 of the car panels 2, 3, 5, 7-9 constituting the elevator car 1 are all identical in configuration and dimension and there is no limit in number of panels to be connected and in interchangeability. However, the second channel-shaped bent portion 14 of the ca panels 4 and 6 for the corners or the like at the left above and the right above in FIG. 1, for example, it modified as shown in FIG. 3.

In FIG. 3, the first channel-shaped bent portion 13 disposed on the connection edge portion 11 of the car panel 3 is the same as that shown in FIG. 2 and heretofore explained. In the second channel-shaped bent portion 14 disposed at the second connection edge portion 12 of the car panel 4 arranged at right angles relative to the car panel 3, the connection portion 34 connected to the second connection edge portion 12 is not bent from the main body portion of the car panel 3 but is an extended portion extended continuously in the direction of its extension, and in other respects the structure is the same.

According to the elevator car panel connection structure of the present invention of the above construction, similar advantageous results as explained in conjunction with FIGS. 1 and 2 can be obtained in connecting the car panels 3 and 4 as well as 5 and 6 defining the corner portions of the car compartment 1.

### Embodiment 3

FIG. 4 illustrates another example of the connection structure that can be used in the corner portion of the car 1, in which example, the connection portion 21 of the first channel-shaped bent portion 13 of the car panel 3 is an extended portion extended in the direction of the the main body portion of the car panel 2. In this case also, advantageous results similar to that of FIG. 3 can be obtained.

Thus, as explained above and shown in FIGS. 3 and 4, it can be said that, in order to connect the car panels at right angles to each other to form the corner portions of the car 1, either one of the first side walls 22 or 29 of the first and the second channel-shaped bent portions 13 and 14 is connected to either one of the connecting portion 21 or 34 continuously extended in straight in the direction of and from the connection edge portion 11 or 12 of the car panel 3 or 4.

### Embodiment 4

FIG. 5 shows a modified example of the elevator car panel connection structure of the present invention, in which the same car panel can be used at the flat wall portion or the corner portion of the wall. In this elevator car panel connection structure, the depth D of the first channel-shaped bent portion 13 of the car panel 2 (the distance from the inner surface of the car panel 2 as viewed from the inside of the car 1 to the inner surface of the bottom wall 23) is made equal to the width B of the inner space (the length of the bottom wall 23 between the first and the second side walls 22 and 24), and the height H of the second channel-shaped bent portion 14 of the car panel 3 (the distance from the inner surface of the car panel 3 to the outer surface of the bottom wall 30) and the outer width C of the body portion (distance between the outer surfaces of the first and the second side walls 29 and 31) are equal to the depth D of the first channel-shaped bent portion 13 of the car panel 3 (A<B=C=D=H).

In this example, the body portion outer width C and the bent portion depth D are equal to the inner space width B, so that the second channel-shaped bent portion 14 can be fit into the inner space 26 of the first channel-shaped bent portion 13 even when its position is changed by 90 degrees. In this example, the second channel-shaped bent portion 14, though the bent portion between the first side wall 29 and the bottom wall 30 is at right angles, after the second channel-shaped bent portion 14 is passed beyond the opening 27 of the width A of the first channel-shaped bent portion 13, the bottom wall 30 of the second channel-shaped bent portion is flexed inwardly by the elasticity of the second side wall 24, whereby the friction between the respective components are maintained.

Thus, according to this example, completely identical car panels can be used both for the flat portion and the corner portion, eliminating the need for several types of the car panels to be used in selective and suitable combination. In this example also, advantageous results similar to those explained in connection with FIGS. 1 and 2 can be obtained.

### Embodiment 5

In the elevator car panel connection structure shown in FIG. 6, the first side walls 22 and 29 of the first and the second channel-shaped bent portions 13 and 14 are connected at an angle to the connecting portions 21 and 28 extending at right angles from the second and the third connection edge portions 11 and 12 of the car panels 2 and 3, respectively, and the opening 27 defined between the first and the second side walls 22 and 24 of the first channel-shaped edge portion 13 receives the second channel-shaped bent portion 14 in a slanted position. In other respects, the structure is the same as those shown in FIGS. 2 and 3.

According to this structure, in addition to the advantageous results that have heretofore been explained, an advantageous result that the connection is not easily disengaged because of the friction by the force acting in the parallel or perpendicular direction relative to the car panel 2 or 3. In particular, even when the passenger leans against the car panel 2 or 3 and a perpendicular force is applied to the panels, or a parallel force is applied to the car panels, the connections between the car panels are not disengaged, so that the safety of the car compartment 1 is increased.

### Embodiment 6

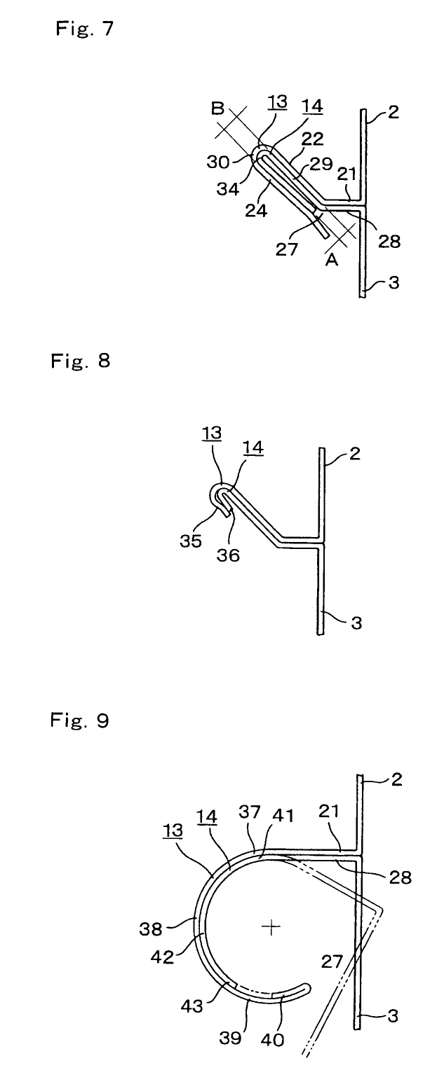

In the elevator car panel connection structure illustrated in FIG. 7, the first side walls 22 and 29 of the first and the second channel-shaped bent portions 13 and 14 are respectively connected at an angle to the connecting portions 21 and 28 perpendicularly extending from the connection edge portions 11 and 12 of the car panels 2 and 3, so that the opening 27 defined between the first and the second side walls 22 and 24 of the first channel-shaped bent portion 13 receives the second channel-shaped bent portion 14 in a slanted direction. In this respect, the structure is similar to those shown in FIG. 6.

However, the bottom wall 30 between the first and the second side walls 22 and 24 of the first channel-shaped bent portion 13 is made extremely narrow in width, the width B of the inner space is about three to four times larger than the thickness of the sheet metal of the car panel 2. The width A of the opening is about two to three times of the thickness of the sheet material of the car panel 2. The second channel-shaped bent portion 14 also has a bottom wall 34 of a still smaller width, the largest width B of the inner space being about the thickness of the sheet material of the car panel 2, for example, and the width A of the opening may be very small or substantially zero.

Thus, according to this example, the second channel-shaped bent portion 14 comprises the first side wall 22 extending along the connection edge portion and the second side wall 24 folded from the first side wall 22 to lay on the first side wall 22. The first and the second side walls are folded, so that the width of the inner space and the width of the opening defined therebetween are very narrow. The first channel-shaped bent portion 13 is made to fit to the configuration and the dimensions of the second channel-shaped bent portion 14, so that the width B of the opening and the width B of the inner space are made smaller as compared to those shown in FIG. 6 for allowing elastic receiving and holding of the second channel-shaped bent portion 14. With such the structure, in addition to the advantages as explained in conjunction with the example shown in FIG. 6, an advantage that the depth dimension of the elevator car panel connection structure can be made small can be obtained.

FIG. 8 illustrates an elevator car panel connection structure which has a very short second side walls 35 and 36 of the first and the second channel-shaped bent portions 13 and 14 as compared to that shown in FIG. 7, resulting in a simple structure and a high reliability.

In FIG. 9 which shows the elevator car panel connection structure having the first and the second channel-shaped bent portions 13 and 14, the first side walls 37 and 41, the bottom walls 38 and 42, and the second side walls 39 and 43 connected to the connecting portions 21 and 28 are all circular cylindrical curved plate members smoothly continuously connected to each other, so that the first and the second channel-shaped vent portions 13 and 14 have general configuration of a hollow cylinder open at one side (C-shaped cross section). The inner diameter, the outer diameter and the opening of the first and the second channel-shaped bent portions 13 and 14 have dimensions that allow the second channel-shaped bent portion 14 snugly fit into the inside of the first channel-shaped bent portion 13 and held there without play. The second side wall 39 has a tip portion that is folded toward inside to provide a stopper 40.

In this connection structure, there are two methods for connecting the first channel-shaped bent portion 13 and the second channel-shaped bent portion 14 together. In the first method, the end portion of the second channel-shaped bent portion 13 is axially slidingly inserted into one of the circular end portion openings at the both ends of the central axis of the first channel-shaped bent portion 14. When both ends of the first and the second channel-shaped bent portions 13 and 14 reach to a predetermined position, the second channel-shaped bent portion 14 is rotated about its axis within the circular first channel-shaped bent portion 13 from the position shown by phantom lines to the position shown by solid lines so that the connecting portions 21 and 28 come to contact with each other. In this position, the car panels 2 and 3 are positioned in the same plane and the front edge of the second side wall 43 of the second channel-shaped bent portion 14 abuts against the stopper 40.

In the second method, both ends of the first and the second channel-shaped bent portions 13 and 14 are placed in alignment and the connecting portion 28 of the second channel-shaped bent portion 14 is inserted into the opening 27 formed along the connection edge portion 12 as shown in phantom in FIG. 9. Then, the front edge of the second side wall 43 of the second channel-shaped bent portion 14 is inserted into the slit-like opening 27 formed along the connection edge portion 11 of the first channel-shaped bent portion 13, and the second channel-shaped bent portion 14 is rotated so that its cylindrical outer surface is slidingly moved along the cylindrical inner surface of the first channel-shaped bent portion 13. When the connection portion 21 and the connection portion 28 are brought into contact with each other and the front edge portion of the second side wall 39 of the second channel-shaped bent portion 13 is brought into abutment against the stopper 40, the car panels 2 and 3 come to positions on the same plane.

According to this elevator car panel connection structure, the car panel can be connected together by the sliding movement along the connection edge portion or the rotating movement. Therefore, differing from the structure utilizing the elasticity of the bent portion, there is no need to make engagement against the elastic force. Also, the front edge portion of the first side wall 39 of the first channel-shaped bent portion 13 is folded inwardly to provide the stopper 40, which abut against the front edge of the second side wall 43 of the second channel-shaped bent portion 14. Therefore, the advantageous results of preventing the disengagement of the connection structure can be obtained not only against the rotational movement of the second channel-shaped bent portion 13 but also against the parallel movement due to a force perpendicular to the axis of the connection structure.

1. An elevator car panel connection structure for connecting car panels constructing elevator car, comprising;
a first channel-shaped bent portion disposed along a connection edge portion of a first car panel and having a channel-shaped cross-sectional configuration defining an opening and an inner space with a width larger than that of said opening; and
a second channel-shaped bent portion disposed along a connection edge portion of a second car panel and having a channel-shaped cross-sectional configuration defining a base portion width that is larger than the width of said opening of said first car panel and that is smaller than the width of said inner space of said first car panel;
whereby said second channel-shaped bent portion is pressure fitted into said inner space of said first channel-shaped bent portion through said opening so that said first channel-shaped bent portion and said second channel-shaped bent portion are elastically connected and held together.

2. The elevator car panel connection structure as claimed in claim 1, wherein
said second channel-shaped bent portion defines an opening and an inner space with a width larger than that of said opening;
each of said first and second channel-shaped bent portion has a first side wall extending along said connection edge portion, a bottom wall connected to said first side wall and a second side wall connected to said bottom wall;
said inner space is defined along said connection edge portion by said first side wall and said second side wall;
said opening is defined along said connection edge portion by said first side wall and said second side wall.

3. The elevator car panel connection structure as claimed in claim 1 or 2, wherein
said first side walls of said first and second channel-shaped bent portions are bent portions perpendicularly extending from said connection edge portions of said car panels;
said bottom wall is a bent portions perpendicularly extending from said first side wall; and
said second side walls are bent portions perpendicularly extending from said bottom wall to oppose to said first side wall.

4. The elevator car panel as claimed in claim 1, wherein
said first channel-shaped bent portion includes a first side wall extending along said connection edge portion, a bottom wall connected to said first side wall and a second side wall connected to said bottom wall:
said inner space is defined along said connection edge portion by said first side wall, said second side wall and said bottom wall;
said opening is defined along said connection edge portion by said first side wall and said second side wall;
said second channel-shaped bent portion includes a first side wall and a second side wall which is a portion of said first side wall folded over along said first side wall.

5. The elevator car panel as claimed in any one of claims 1-4, wherein
said second side wall of said first channel shaped bent portion includes a guide portion for guiding said second channel-shaped bent portion into said opening.

6. The elevator car panel as claimed in any one of claims 1-5, wherein
said first side wall of said first and second channel-shaped bent portions are connected to a connection portion extending from said connection edge portions of said car panels perpendicularly with respect to said car panels.

7. The elevator car panel as claimed in any one of claims 1-7, wherein
said first side walls of one of said first and second channel-shaped bent portions is connected to a connection portion extending from said connection edge portion in parallel with respect to said car panel.

8. The elevator car panel as claimed in any one of claims 1-7, wherein
said first side wall of said first and second channel-shaped bent portions is connected, with an angle, to a connection portion extending perpendicularly from said connection edge portion of said car panels.

9. An elevator car panel connection structure for connecting car panels constructing elevator car, comprising;
a first channel-shaped bent portion disposed along a connection edge portion of a first car panel and having a C-shaped cross-sectional configuration defining an opening elongated along said connection edge portion and an inner space with a width larger than that of said opening; and
a second channel-shaped bent portion disposed along a connection edge portion of a second car panel and having a C-shaped cross-sectional configuration defining a cylindrical outer surface fitted within said cylindrical inner space of said first car panel; and
a stopper disposed at the tip portion of said first channel-shaped bent portion to extend into said inner space for abutting against a tip portion of said second channel-shaped bent portion to prevent a movement beyond that point when said second channel-shaped bent portion is inserted into said inner space of said first channel-shaped bent portion.
